(19) United States
(12) Patent Application Publication
(10) Pub. No.: US 2002/0169756 A1
(43) Pub. Date: Nov. 14, 2002

(54) Voting system and method for secure voting with increased voter confidence

(76) Inventor: David L. Biddulph, New Smyrna Beach, FL (US)

Correspondence Address: GUNSTER, YOAKLEY & STEWART, PA, BROWARD FINANCIAL CENTRE, SUITE 1400, 500 EAST BROWARD BLVD, FT LAUDERDALE, FL, 33394, US

(21) Appl. No.: 09/852,877

(22) Filed: May 10, 2001

(51) Int. Cl. G06F 7/00

(52) U.S. Cl. 707/3

(57) ABSTRACT

An information gathering system and method that utilizes a computer to authenticate, poll and store user responses to a customized questionnaire. The questionnaire can be a ballot. The computer utilizes various databases to authenticate and generate the customized questionnaire. The computer records user responses securely and anonymously. User and/or system errors are eliminated before finalizing the response database. A unique identifier is assigned to each user which allows the user to verify the integrity of the user's response by accessing a response database.

### CROSS-REFERENCE TO RELATED APPLICATION

N/A

### STATEMENT REGARDING FEDERALLY SPONSORED RESEARCH OR DEVELOPMENT

N/A

### FIELD OF THE INVENTION

The present invention relates to an information gathering system and method, and in particular, to a voting system and method that greatly reduces errors common to voting systems while maintaining voter anonymity.

### BACKGROUND OF THE INVENTION

As was graphically illustrated by the 2000 Presidential Election in the United States, a key element in a representative form of government is the ability of the electorate to participate in a meaningful way in the electoral process and do so in a way that engenders a high degree of confidence in the results.

Various voting systems have been known for thousands of years but it was not until the second half of the 19th Century that voting machines were introduced. One of the factors that led to a push for mechanizing the vote was the relatively new concept of a general “secret” ballot. The introduction of the machine to the process of voting held the promise of simplifying a secret ballot process while providing faster, more reliable results free from the error and corruption often associated with hand counting of votes. Although the widespread use of voting machines is a testament to the fulfillment of at least some of their potential, in actual practice, the machines have not always lived up to their promise.

One limitation of prior voting systems that hampers voter confidence is related to the “secret ballot” concept that has come to be regarded as a sacred right by the populace. The fact that no one has a “right to know” how a person votes, while encouraging “voting your conscience,” undermines the ability to be sure that every vote has been counted and counted the way the voter intended. Additionally, voter confidence is influenced by the knowledge that we all make mistakes and no equipment is perfect but, traditionally, once the vote is cast, there is little that the voter can do to recheck the accuracy of their vote, correct simple mistakes or even know how the election equipment actually recorded their vote.

It is therefore desirable to have a system and method which allows a voter to cast a vote in a simple manner while preserving the secrecy of the vote as well as allows the voter to confirm that the vote was counted in the official election tabulation in accordance with the voter's intent.

### SUMMARY OF THE INVENTION

The present invention advantageously provides an information gathering system utilizing a computer and databases accessible by the computer. Input devices such as a keyboard, scanner, microphone or touch screen are coupled to the computer as well as an output device such as a printer. A software program is utilized by the computer to perform the present invention.

According to one aspect, the present invention provides an information gathering system that uses at least one computer and an identification database accessible by the computer. The identification database includes user identification information. At least one output device is coupled to the computer. An executable software component is executable by the computer and is arranged to validate the user and cause the computer to provide output on the output device corresponding to a customized ballot prepared based upon a validated user response to a specified request for information.

According to another aspect, the present invention provides a method of gathering information about a user using a computer in which the user's eligibility to participate by consulting a first database is verified. A unique identifier is assigned to an eligible user. A questionnaire is customized by consulting a second database. The eligible user is required to provide to the computer a response to the questionnaire. A first tangible record of the response is produced. A second tangible record of the response is produced. The second tangible record is collected and stored.

According to yet another aspect, the present invention provides a method of voting using a computer in which the eligibility of a potential voter is checked by accessing a voter eligibility database. The potential voter who is deemed to be a non-eligible voter is rejected. An address of an eligible voter is received. A ballot based on a selected criteria is customized by accessing a ballot form database. The ballot is displayed to the eligible voter on a screen, on paper, via audio speaker or other suitable device. The voter indicates their ballot selections. The ballot is received from the eligible voter and checked for errors by comparing the ballot to a selected standard. An official ballot is printed and collected. A receipt is also printed.

According to a further aspect, the present invention provides an information gathering system, which utilizes a means for identifying a user. Once the user is identified, the system provides a means for verifying the user's status to participate in the information gathering system and a means for assigning a unique identifier to the user. The system further uses a means for displaying a customized questionnaire, the customized questionnaire prompting the user to enter at least a first response to at least one question on the customized questionnaire. A means for storing the first response, and a means for producing a tangible record of the first response and the unique identifier, is also provided for by the present invention. The system further provides a means for allowing the user to compare the tangible record with the first response, as well as a means for correcting a discrepancy between the tangible record and the first response.

According to yet a further aspect, the present invention provides a method of gathering information in which a user's status to participate in the information gathering system is verified. A unique identifier is assigned to the user. A customized questionnaire is displayed to the user. The user is prompted to enter at least a first response to at least one question on the customized questionnaire. At least the first response is stored. A tangible record of at least the first response and the unique identifier is produced and retained by the user. The user compares the tangible record with at least the first response and corrects any discrepancies therein by overwriting the most recent response stored.

According to another aspect, the present invention provides a method of voting which preserves the secrecy of the ballot while allowing a voter to verify the integrity of a vote in which the eligibility of a potential voter is checked by accessing a voter eligibility database. A unique identifier is generated and assigned to an eligible voter. A customized ballot is printed which conforms to one or more selected criteria. The completed ballot is scanned. The scanned ballot is compared with a predetermined standard to detect voter errors. An error report is printed if an error is detected. An official ballot and receipt is printed if no errors are detected. The official ballot is collected and stored The vote totals are transmitted to a central vote tabulation database where the voter can check to determine their vote was counted accurately.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an illustration of a typical election workstation configured according to an embodiment of the invention;

FIG. 2 is a flow chart outlining the steps required to produce a custom ballot according to an embodiment of the invention;

FIG. 2A is a flow chart outlining the steps required to produce a custom ballot according to an embodiment of the invention;

FIG. 3 is a flow chart showing a voting process according to an embodiment of the invention;

FIG. 4 is a flow chart demonstrating voter error checking according to an embodiment of the invention;

FIG. 5 is a flow chart of a vote verification process according to an embodiment of the invention;

FIG. 6 is a flow chart showing a vote recount according to an embodiment of the invention;

FIG. 7 is a block diagram of a reporting arrangement according to an embodiment of the invention;

FIG. 8 is an example of an input ballot arranged according to an embodiment of the present invention;

FIG. 9 is an example of a voter receipt arranged according to an embodiment of the invention;

FIG. 10 is an example of an official ballot printed in accordance with an embodiment of the present invention; and

FIG. 11 is an example of an error report generated according to an embodiment of the present invention.

### DETAILED DESCRIPTION OF THE INVENTION

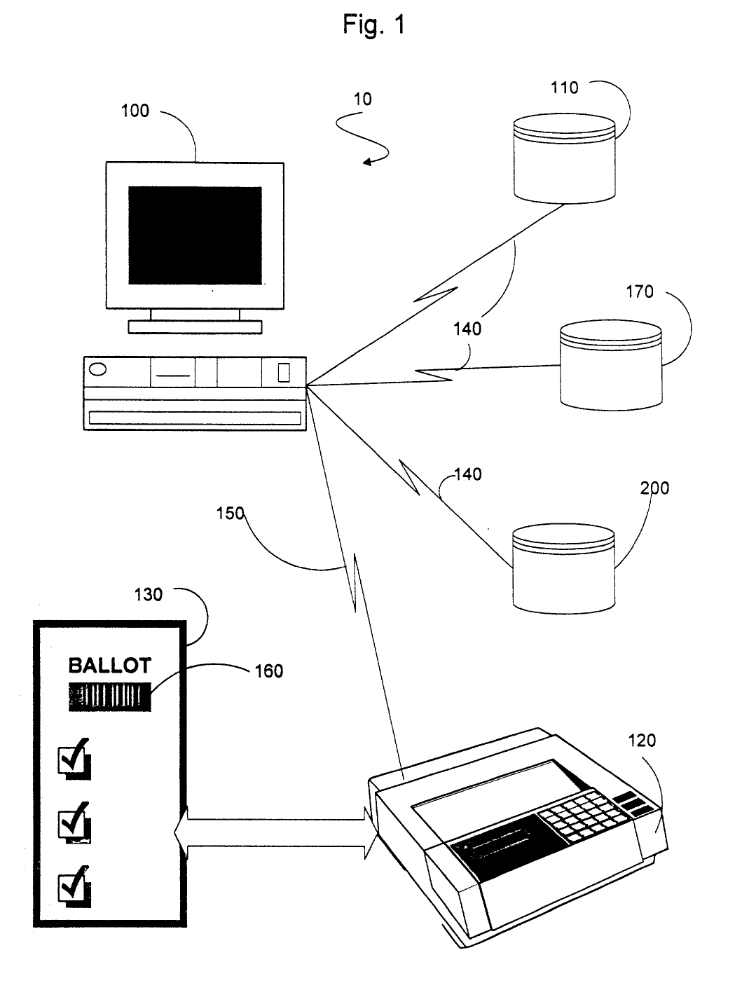

Referring to FIG. 1, a election workstation, shown generally as 10, includes a computer 100 connected to a ballot form database 110, a printer/scanner 120, a voter registration database 170, and a local recorded vote database 200. Printer/scanner 120 may be locally connected to computer 100 or networked by connecting to a communication network 150 such as a local area network (LAN) or the Internet. Several election workstations 10 can be used at a single polling location depending on the size of the precinct. Ballot form database 110 and voter registration database 170 can physically reside on a storage device such as a hard-drive or CD-ROM in each computer 100 or ballot form database 100 and/or voter registration database 170 may be connected across a network. It is also possible to access ballot form database 110 or voter registration database 170 by connecting to a communication network 140 such as the LAN or Internet. Although ballot form database 110 and voter registration database 170 are shown as separate components, it is understood that the ballot form database 110 can physically reside in computer 100 or even at a remote location connected through the communication network 140. It should also be evident that a separate scanner and separate printer can be used in place of integrated printer/scanner 120.

Computer 100 is provided with a software component that is typically written in a machine-readable language such as C++ or Visual Basic or any acceptable programming language. The software component performs any of the functions described herein including enabling computer 100 to receive and output information.

Printer/scanner 120 is used to produce a paper ballot 130. Ballot form database 110 includes ballot information for all national, state and local elections, allowable language options, and an audio version or other accessibility enhanced options for the disabled. Ballot form database 110 and voter registration database 170 are present in all polling places within the election jurisdiction thus allowing the eligible voter to cast their ballot at any polling place within the election jurisdiction regardless of where the voter is actually registered to vote. In order to ensure that a voter does not vote more than once, any voters who choose to vote at an election polling place other than their assigned polling place will have their vote placed on hold until compared with the voting data from the rest of the election jurisdiction. If the voter has not registered another vote, the vote becomes official and is entered into the tally. If the voter is shown to have voted at more than one location, the votes are not entered and the name and address may be given to the authorities for further investigation. Because paper ballots are printed as needed, the cost of preprinting the ballots is eliminated and waste is reduced. Only ballots actually needed are printed.

Ballot 130 includes a computer generated unique identifier or identification number 160 that is used for security and identification. Number 160 may be a random number or other securely generated number as is known in the art Ideally, number 160 should be large enough to provide an extremely high level of confidence, reducing the chance of two voters being assigned the same number 160 to almost zero. Additionally, number 160 may be encoded so that number 160 is not readily interpretable, further increasing security. Bar coding or any other suitable method may be used.

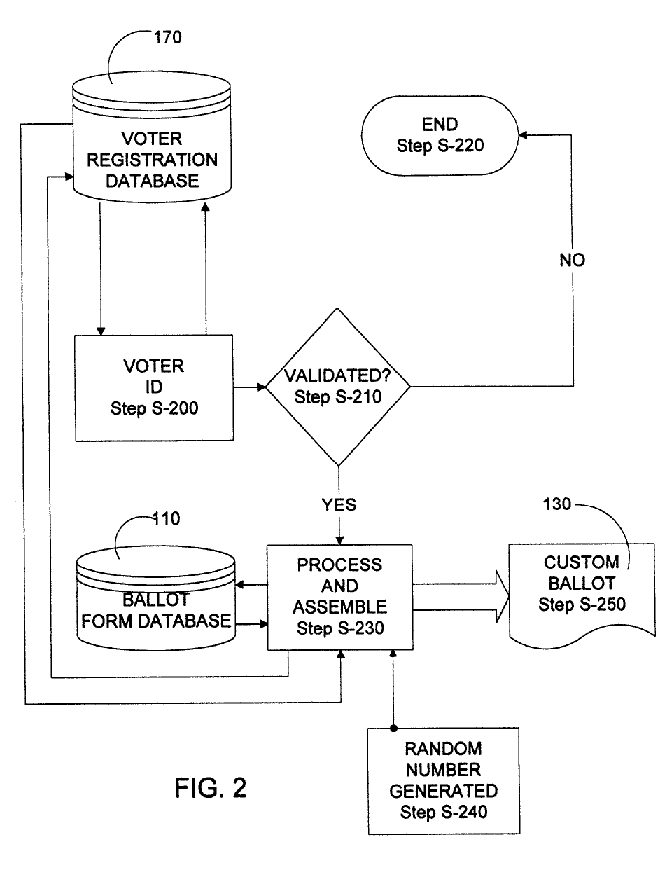

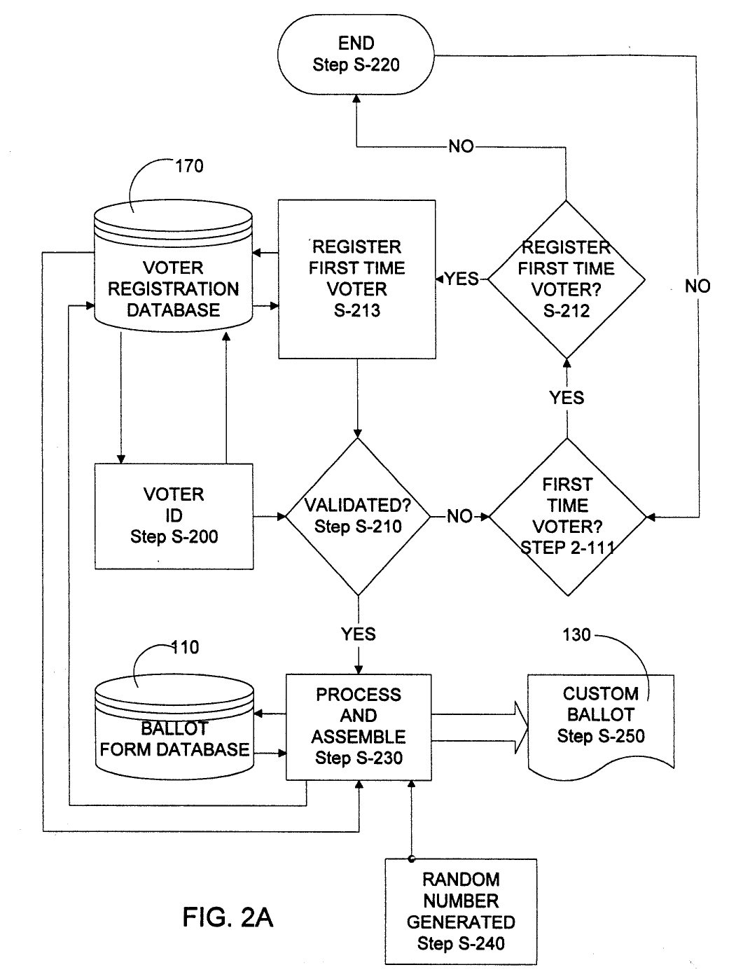

Ballot production is explained with reference to FIG. 2. Initially, a voter presents an acceptable form of identification (step S-200) to initiate the voting process by referring to voter registration database 170. Examples of acceptable identification include a driver's license, state issued identification or voter registration card. The voter is validated in step S-210 if the identification presented matches the voter's information stored in voter registration database 170 and the voter has not previously recorded a vote in the present election. It is contemplated that validation step S-210 is performed by a human election worker; however, it is known to electronically verify a person's identity and any acceptable form of validation may be used to perform step S-210. Biometric devices, for example, are known in the art and could be adapted to perform validation step S-210.

In some states, it is possible to register the day of the election, even if the voter has never registered before. The process involved, when a first time voter registers the day of the election, is shown by referring to FIG. 2A. The steps are similar to the steps detailed above except that if the voter is not validated and is a first time voter in a state allowing same day registration (step S-211), the first time voters may be given the opportunity to register for the first time (step S-212) according to one embodiment of the invention. If the first time voter does not wish to register, the process ends (step S-220). First time voters who want to register may be registered (step S-213) by updating voter registration database 170. The registered first time voter is validated in step S-210 and the process continues in a manner identical for validated, already registered voters

If the voter cannot be validated or has previously voted in the present election, the voting process ends (step S-220). The voter may be referred to an election supervisor. It is possible for the election supervisor to “conditionally validate” and place the vote on hold in the same manner as when a voter chooses to vote at a polling place other than the one to which he or she is assigned.

If the voter is validated, the relevant information (i.e., name and address) is processed within computer 100 (step S-230) by referring to ballot form database 110 and voter registration database 170. Voter registration database 170 contains the name, address, registration number, signature, identification information, and a record of any previous vote cast in the present election for all registered voters in the election jurisdiction. Voter registration database 170 is checked to make sure the voter is registered, confirm the voter's identification via signature verification and/or identification number and prohibit the voter from voting more than once in the same election. Ballot form database 110 may be provided by a state or local election board or may be independently compiled by a third party. Ballot form database 110 includes a complete listing of all approved legal ballots within a voting jurisdiction. The comprehensive voting jurisdiction-wide ballot form database 110 and voter registration database 170 allows voters the option to vote at any polling location within the voting jurisdiction rather than only at the polling location assigned to them.

In step S-230, ballot 130 is processed and assembled by referring to ballot form database 110, voter registration database 170 and generating a unique identification number 160 (step S-240). Any suitable method for generating a unique identifier 160 may be utilized. Unique identifier 160 is printed on ballot 130, thereby producing a custom ballot (step S-250) that includes all the information required on a legal ballot based on the voter's identity, address and allowable language preference as validated in step S-210 along with unique identification number 160. Although the invention is described as producing paper custom ballot 130, it is readily apparent to one skilled in the art that custom ballot 130 can be rendered on any suitable medium as long as ballot 130 functions as input to the voting system. For example, ballot 130 can be electronically displayed on a touch screen computer monitor allowing a voter to touch the screen thereby indicating his or her vote. It is possible for a visually impaired voter to use the present invention by using an electronic transmission device such as a telephone, computer, personal digital assistant or cellular phone to enter the voter's identification information as well as the vote. The system 10 accepts speech entry of information and voting choices and provides audio feedback to the visually impaired voter. Such speech recognition systems are known in the art and any suitable audio system that allows the present invention to be practiced without a printed ballot is acceptable.

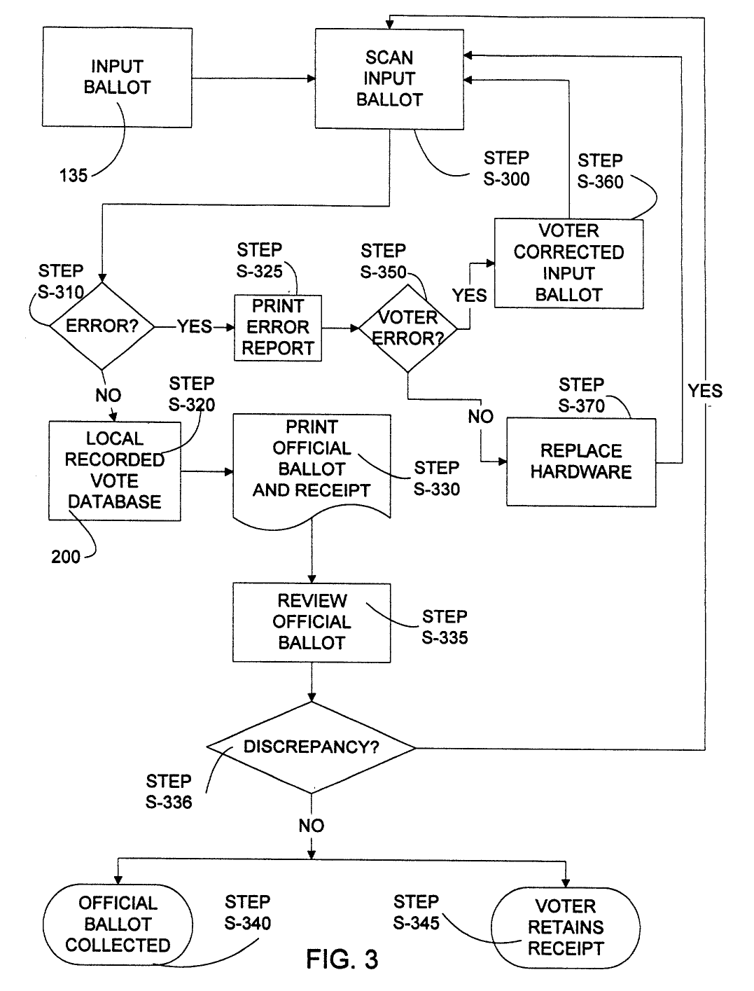

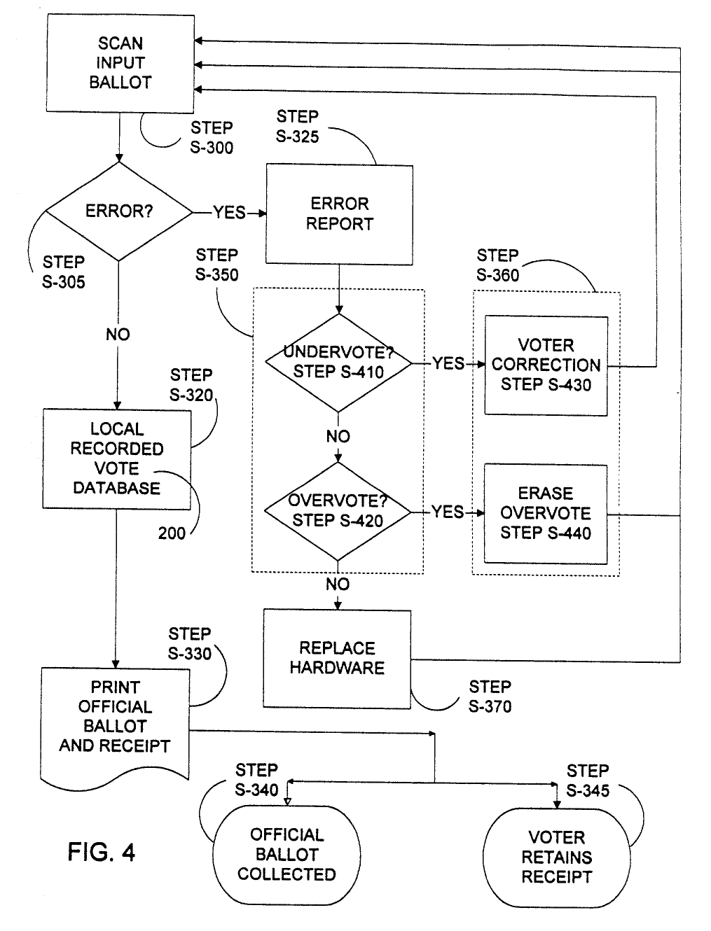

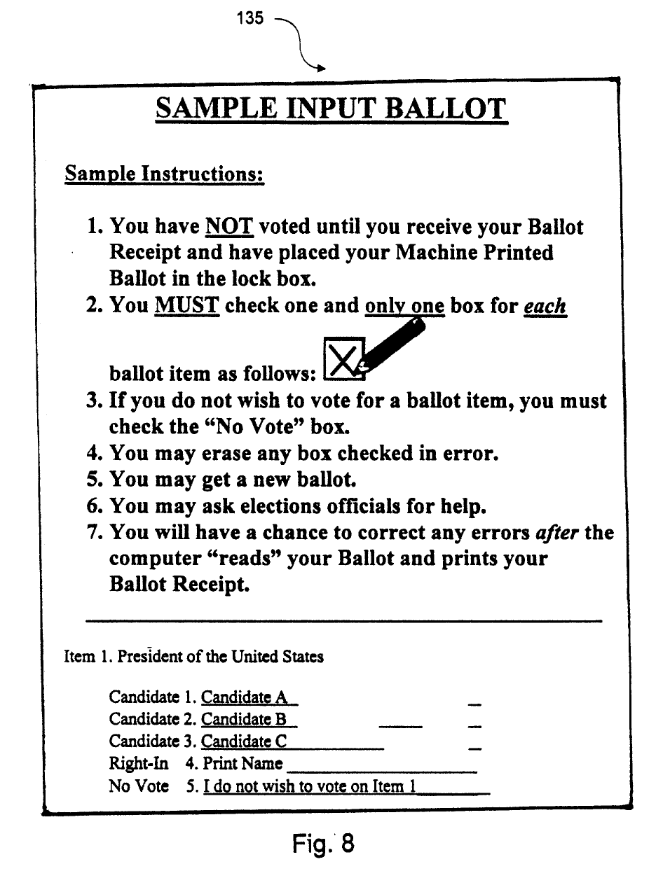

The voting process of the present invention is explained with reference to FIGS. 1, 3, 4, 7 and 8. The voter fills out his or her ballot 130 by blackening or checking the box corresponding to the selection (or pressing the screen or speaking the selection as discussed above.) The completed ballot 130 becomes an input ballot 135, an example of which is shown in FIG. 8. Input ballot 135 is scanned (step S-300) using scanner/printer 120. An error detection routine (step S-310) is used to detect any errors in input ballot 135. Examples of errors include overvotes and undervotes, and will be described in more detail below. If no errors are detected, the vote is tallied by entering the error free vote (step S-320) into local recorded vote database 200.

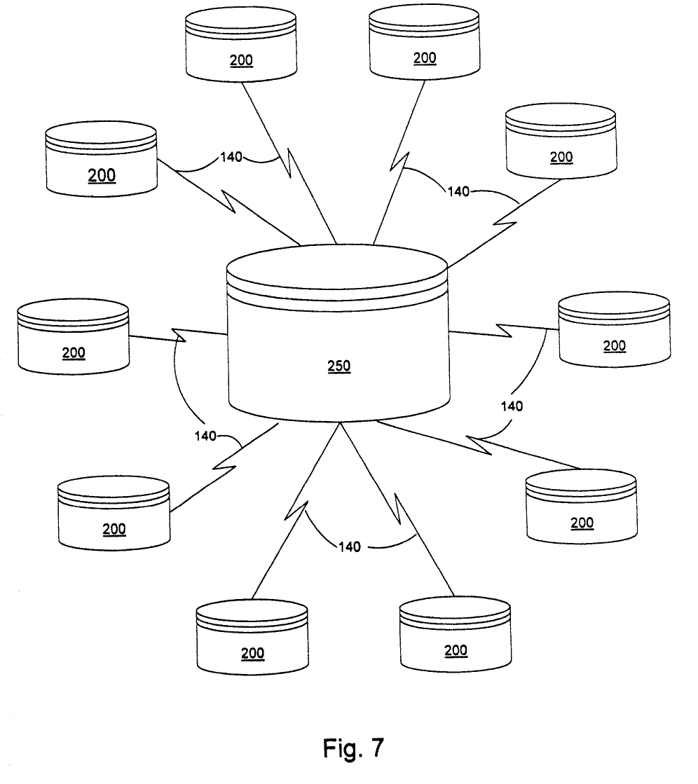

As shown in FIG. 7, local recorded vote database 200 may be linked to a central recorded vote database 250. Local recorded vote database 200 is used by the election workstation 10 to store and tabulate all error free ballots. In order for the results of the election to be determined, all individual local recorded vote databases 200 must be counted. Central recorded vote database 250 is used to tabulate the results from local recorded vote databases 200. A communication network such as the Internet may be used to transmit the data from local recorded vote databases 200 to central recorded vote database 250.

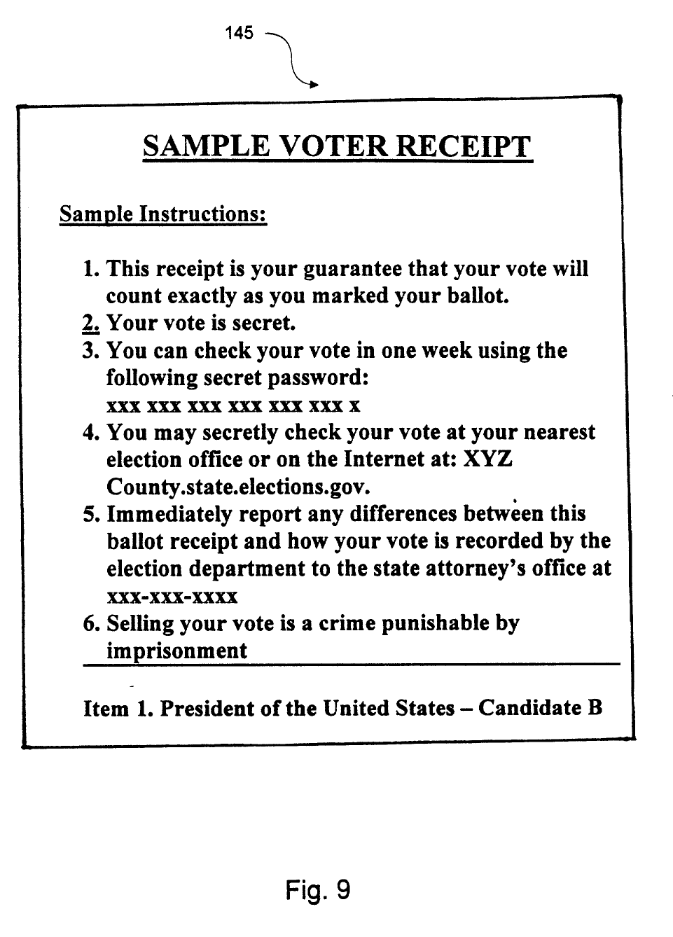

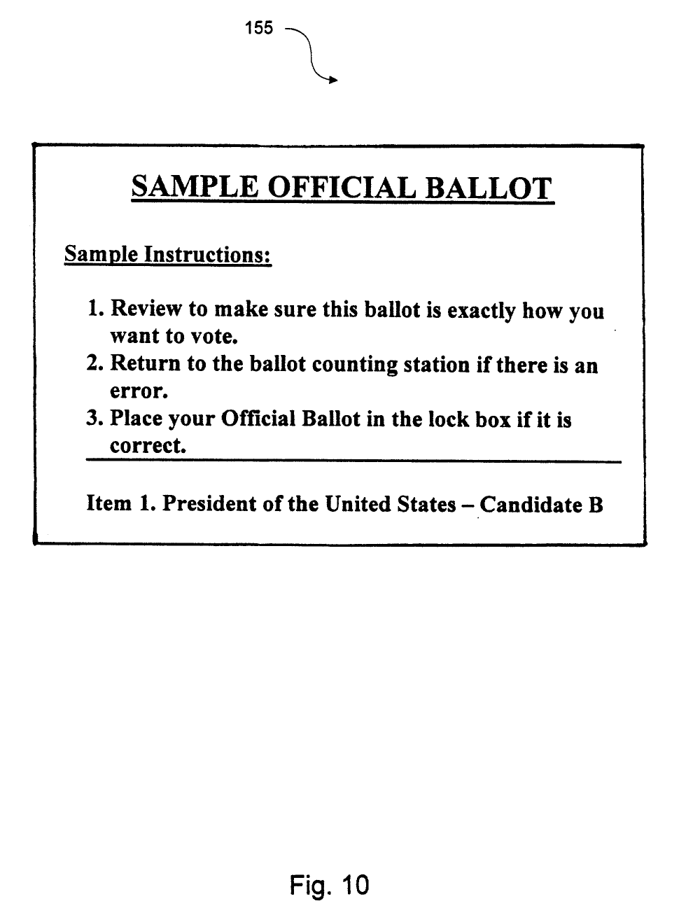

Once the vote has been entered into local recorded vote database 200 (step S-320), scanner/printer 120 is used to print an official ballot 155 and a voter receipt 145. An example of voter receipt 145 and official ballot 155 are shown in FIGS. 9 and 10 respectively. The voter is given their official ballot 155 and voter receipt 145 and the voter reviews official ballot 155 (step S-335). If the voter determines there is a discrepancy between their intent and official ballot 155, they may change input ballot 135 and re-enter it into local recorded vote database 200 (step 336). Local recorded vote database 200 is accessed using unique identification number 160 and, upon verification of unique identification number 160, the original vote is erased and the data from re-entered input ballot 135 is recorded. Official ballot 155 is collected by election officials (step S-340) and secured. Official ballot 155 is used when the results of an election are in dispute. Official ballot 155 provides a very accurate paper record which indicates clear voter intent without the possibility of voter error. The voter retains receipt 145 (step S-345). Both official ballot 155 and voter receipt 145 also have unique identification number 160 printed thereon.

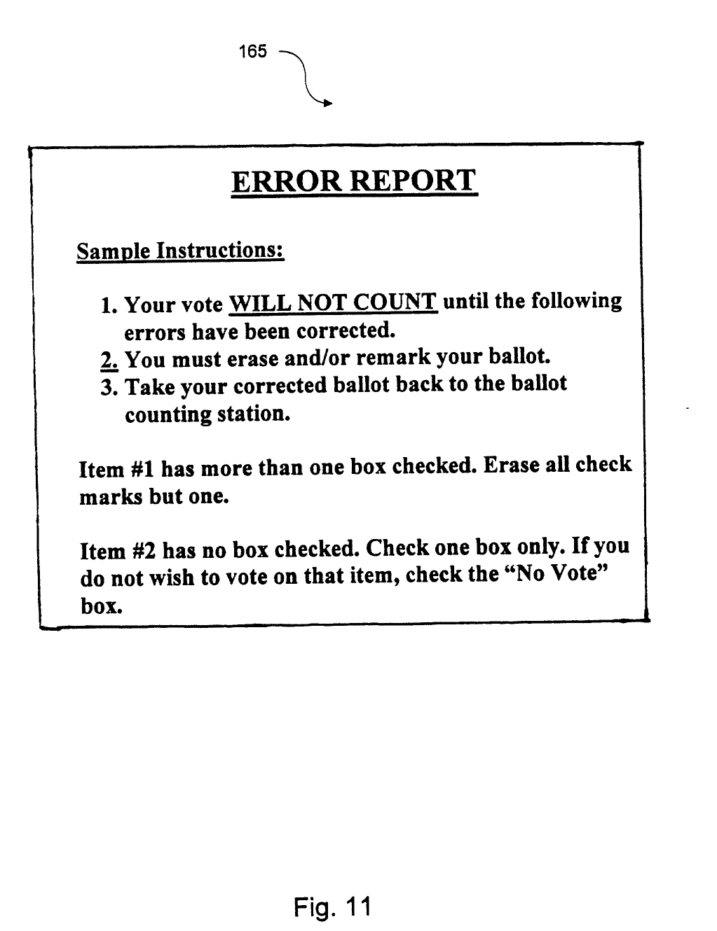

If an error is detected (step S-310), it is necessary to determine what kind of error exists (step S-350). As discussed above, voter error includes overvotes and undervotes. Non-voter error is classified as a technological breakdown such as when scanner/printer 120 is unable to accurately read input ballot 135 and also includes software errors, power failures and other like problems. An error report 165 is generated (step S-325) and indicates the kind of errors detected. An example of error report 165 is shown in FIG. 11. Voter error is discussed first.

As noted above, voter error can be broken down into two basic categories. The first is known as an overvote. An overvote occurs when a voter selects more than one choice for a single ballot item. Examples include selecting two candidates for the Office of President, or choosing both yes and no on a bond issue. Overvotes are easily detected by the system 10.

Likewise, undervotes are easily detected and occur when no vote appears for a ballot item. Examples of undervotes include no choice indicated for president or a completely blank ballot. Although all ballot items left blank are potentially undervotes, voters can leave a particular item blank and the voter's intent to leave an item blank must be distinguished from voter error or neglect. Input ballot 135 has a “no vote” box that a voter uses to indicate that he or she does not intend to make a choice for a particular ballot item. An example of input ballot 135 is shown in FIG. 8. An input ballot containing a checked “no vote” box will not result in an error.

When either an undervote or overvote error is detected (step S-350), error report 165 is generated (step S-325). The voter is given error report 165 and original input ballot 135. The voter then corrects input ballot 135 (step S-360) by erasing overvotes or stray marks (step S-440), and/or by selecting a choice or marking “no vote” on undervotes (step S-430). It is possible to issue the voter a new customized ballot 130 in which a new unique identification number 160 is generated by first instructing system 10 to erase all votes recorded in local recorded vote database 200 for the original input ballot 135 using the unique identifier that was generated and printed on the original ballot. The corrected (or new) ballot 135 is scanned (step S-300) and the process repeats to ensure all errors are corrected and no new errors are introduced.

If it appears that input ballot 135 is marked correctly, yet system 10 rejects input ballot 135 as having an error, hardware such as a scanner/printer 120 may be replaced (step S-370). Once the hardware has been replaced, input ballot 135 is rescanned (step S-300) and the process repeats. If the error persists, the entire system 10 may be replaced.

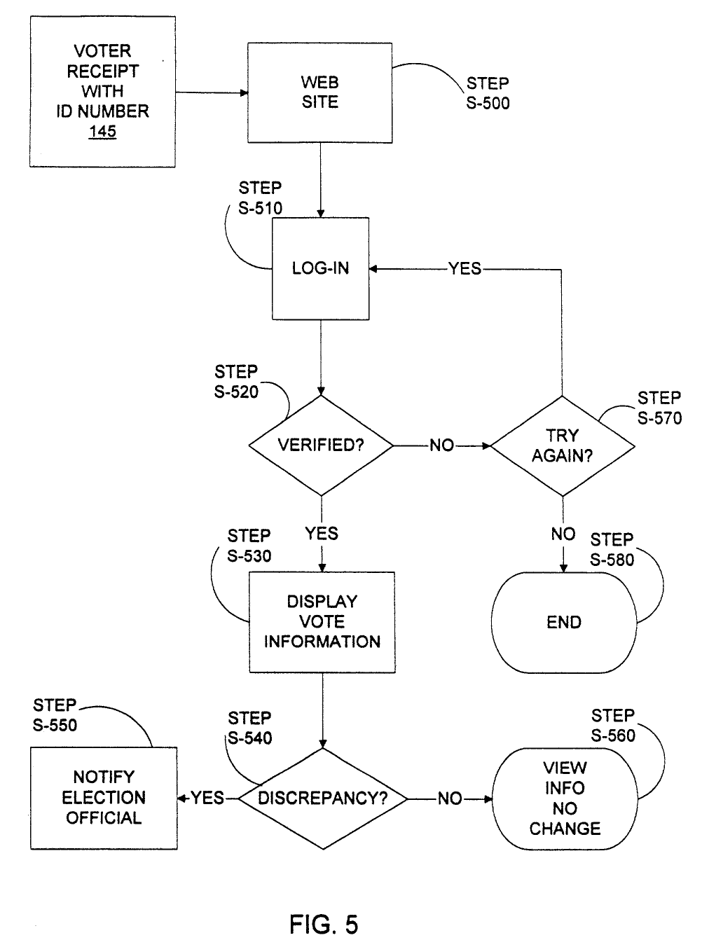

The process of allowing the voter to audit the accuracy of their vote in the election tabulation database while preserving the voter's anonymity is explained with reference to FIGS. 5 and 7. The voter accesses a communication network such as the Internet and visits a specialized site such as a website (step S-500). Using unique identification number 160, the voter attempts to log in (step S-510) to central recorded database 250 using a secure method such as SSL (secure socket layer) as is known in the art. If the voter is verified (step S-520), a vote information screen is displayed (step S-530). Of course, the voter may be presented with other intermediate screens with links to a screen displaying the recorded vote associated with unique identification number 160 as is known in the art The voter then verifies that his or her vote, as recorded on receipt 145, matches the information displayed on the screen (step S-540). If there is a discrepancy, the proper election official is notified (step S-550). The notification may be by e-mail or any other suitable notification means (i.e., telephone, mail, etc.). If no discrepancy is detected, the voter confirms the accuracy of his or her vote (step S-560). This arrangement engenders a great deal of voter confidence in the integrity of system 10.

If the voter is unable to be verified (step S-520), the voter may be asked to try again (step S-570) and re-enter unique identification number 160 (step S-510), or else the process ends (step S-580). Of course, the voter may be redirected to help screens or disconnected from the website after a predetermined number of unsuccessful log-in attempts are exceeded as known in the art to minimize the possibility of compromising the security of system 10.

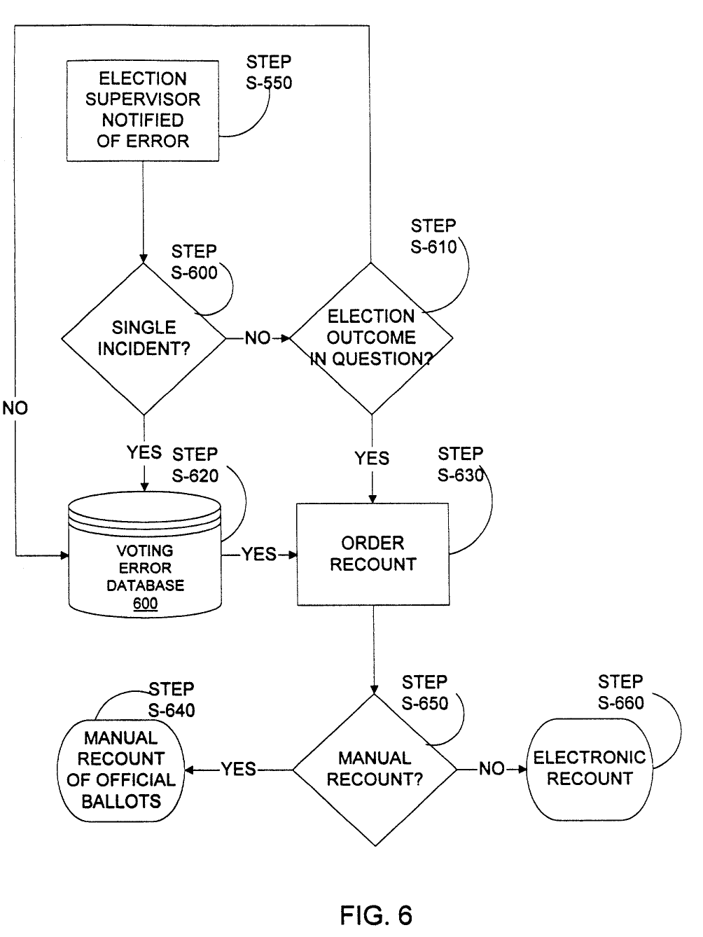

FIG. 6 illustrates how a discrepancy can be dealt with once the election supervisor is notified (step S-550). If the discrepancy is a single incident (step S-600) with no clear discernable pattern suggestive of a more serious problem, the single incident is sent to a voting error database 600 in order to monitor and detect any potential problems (step S-620). Should the database reveal any systemic errors or other patterns of error which could affect the outcome of an election, the election supervisor can order a recount (step S-630). If a recount is ordered, it may be an electronic recount (step S-660) of the data from one or more local recorded vote database(s) 200. If the discrepancy is not resolved, or at the discretion of the election supervisor, a manual recount of the collected and secured official ballots 155 may be ordered (step S-640). This recount may be performed electronically or by actual human inspection and provides an independent, highly reliable and clear record of voter intent.

Voter error database 600 can include a “trigger” which orders a recount if the number of reported discrepancies exceed a certain level which could affect the outcome of the election (step S-630). If the discrepancies are widespread (step S-600), the outcome of an election may be impacted and a recount may immediately be ordered (step S-630). The recount proceeds as discussed above. If the outcome of the election is not in question, the multiple discrepancies are stored in voting error database 600 as discussed above.

As discussed above, each polling location either has or is connected to local recorded vote database 200. Local recorded vote database 200 stores all the error free votes. The information contained in each local recorded vote database 200 and voter registration database 170 needs to be centrally compiled to facilitate a final tally as well as to clear those votes which are on hold and considered provisional from voters choosing to cast their ballots at a location other than the one where they are registered. The central compilation also serves to detect multiple votes from a single registered voter using voter registration database 170.

Central recorded vote database 250 is used to compile and process the data from local recorded vote databases 200. Local recorded vote databases 200 upload the data using a communication network 140 such as the Internet to communicate with central recorded vote database 250. Any acceptable means of transmitting the data from local recorded vote database 200 to central recorded vote database 250 may be used including physically transporting local database 200 or copies of the data to central database 250.

Although the invention has been described in terms of voting and elections, the invention is perfectly suited for use as a polling system unrelated to voting such as a survey or other information gathering application. Those skilled in the art would readily recognize that little, if any, modification would be needed to gather survey information using the present invention.

Another embodiment of the present invention, referring again to FIGS. 1-5, utilizes a home, office or publicly available computer and a communication network such as the Internet to access voting system 10 from a location other than an official voting station. The voter accesses a voting website and logs in (step S-510) as discussed above. Once validated and confirmed as a registered voter in voter registration database 170 who has not previously voted in the present election (step S-200), the voter is presented with a custom ballot (step S-250) on his or her computer screen. The voter selects his or her choices on electronic ballot 130 and the votes are directly checked for errors (step S-310). Scanning ballot 130 in step S-300 is not needed. The rest of the process proceeds as discussed above except that because the voter is not physically at a voting station, the voter must print and deliver official ballot 155 with unique identifier 160 to the proper election officials. The voter may deliver official ballot 155 by mail, hand delivery or any other acceptable delivery method that includes proper identification as a registered voter such as by signature verification. The voter also prints and retains voter receipt 145 with the unique identifier 160 for use in verifying his or her vote as described above.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. An information gathering system, comprising:
at least one computer;
an identification database accessible by the computer, the identification database including user identification information;
at least one output device coupled to the computer; and
a software component executable by the at least one computer, the software component being arranged to validate the user and cause the computer to provide output on the output device corresponding to a customized ballot prepared based upon a validated user response to a specified request for information.

2. The system according to claim 1, further comprising an input device coupled to the computer wherein the software component is further arranged to read a completed customized ballot from the input device, check the completed customized ballot for errors and to cause the computer to provide output to the output device corresponding to the completed customized ballot.

3. The system according to claim 1, wherein the software component is also arranged to assign a unique identifier to the validated user.

4. The system according to claim 3, further including a forms database accessible by the computer, the forms database including form formatting and content information.

5. The system according to claim 4, wherein the forms database corresponds to an official ballot forms database.

6. The system according to claim 3, further comprising:
a tabulation database accessible by the validated user by verifying the unique identifier assigned to the validated user.

7. The system according to claim 6, wherein the tabulation database corresponds to an official vote tabulation database.

8. The system according to claim 6, wherein the validated user accesses the tabulation database via a communication network.

9. The system according to claim 8, wherein the communication network is the Internet.

10. The system according to claim 3, wherein the unique identifier is a randomly generated number.

11. The system according to claim 1, wherein the specified request for information includes at least one of a request for validated user's address and a request for an allowable language preference.

12. A method of gathering information about a user using a computer, comprising:
verifying that the user is eligible to participate by consulting a first database;
assigning a unique identifier to an eligible user;
customizing a questionnaire by consulting a second database;
requiring the eligible user to provide to the computer a response to the questionnaire;
producing a first tangible record of the response;
producing a second tangible record of the response;
collecting the second tangible record; and
storing the second tangible record.

13. The method according to claim 12, further comprising rejecting users not listed in the first database.

14. The method according to claim 13, wherein requiring the verified user to provide to the computer a response to the questionnaire comprises:
inputting the response into the computer;
checking the response by comparing the response to a selected standard;
rejecting the response if the response does not meet the requirements of the selected standard; and
requiring the verified user to correct the rejected response.

15. The method according to claim 14, wherein the selected standard includes a single choice indicated for each individual questionnaire item.

16. The method according to claim 14, wherein the first database is an identification database comprised of user identification information.

17. The method according to claim 14, wherein the first database corresponds to an official voter registration database.

18. The method according to claim 14, wherein the first database is comprised of a list of registered voters.

19. The method according to claim 12, wherein the second database is a forms database, the forms database being comprised of form formatting and content information.

20. A method of voting using a computer, the method comprising:
checking the eligibility of a potential voter by accessing a voter eligibility database;
rejecting the potential voter who is deemed to be a non-eligible voter;
receiving an address of an eligible voter;
customizing a ballot based on a selected criteria by accessing a ballot form database;
displaying the ballot to the eligible voter;
receiving the ballot from the eligible voter;
checking the ballot for errors by comparing the ballot to a selected standard;
printing an official ballot;
collecting the official ballot; and
printing a receipt to be retained by the eligible voter.

21. The method according to claim 20, further comprising:
assigning a unique identifier to the eligible voter;
causing the unique identifier to be printed on the receipt and the official ballot;
updating a voting results database with the ballot received from the eligible voter;
providing access to the voting results database to the eligible voter; and
requiring the eligible voter to input the unique identifier in order to gain access to the voting results database.

22. The method according to claim 20, wherein the selected criteria includes at least one of the eligible voter's address and allowable language preference.

23. The method according to claim 21, wherein the unique identifier is a randomly generated number.

24. The method according to claim 20, further comprising receiving language preferences from the voter.

25. The method according to claim 20, further comprising receiving handicap access preferences from the voter.

26. The method according to claim 24, further comprising receiving handicap preferences from the voter.

27. The method according to claim 21, wherein the voting results database corresponds to an official voting results database.

28. An information gathering system, comprising:
means for identifying a user;
means for verifying the user's status to participate in the information gathering system;
means for assigning a unique identifier to the user;
means for displaying a customized questionnaire, the customized questionnaire prompting the user to enter at least a first response to at least one question on the customized questionnaire;
means for storing the at least first response;
means for producing a tangible record of at least the first response and the unique identifier;
means for allowing the user to compare the tangible record with the at least first response; and
means for correcting a discrepancy between the tangible record and the first response.

29. A method of gathering information, comprising:
identifying a user;
verifying the user's status to participate in the information gathering system;
assigning a unique identifier to the user;
displaying a customized questionnaire, wherein the user is prompted to enter at least a first response to at least one question on the customized questionnaire;
storing the at least first response;
producing a tangible record of at least the first response and the unique identifier, wherein the user retains the tangible record;
allowing the user to compare the tangible record with the at least first response; and
correcting a discrepancy between the tangible record and the first response.

30. A method of voting which preserves the secrecy of the ballot while allowing a voter to verify the integrity of a vote, comprising:
checking the eligibility of a potential voter by accessing a voter eligibility database;
generating and assigning a unique identifier to an eligible voter;
printing a customized ballot which conforms to one or more selected criteria;
scanning the completed ballot;
comparing the scanned ballot with a predetermined standard to detect voter errors;
printing an error report if an error is detected;
printing an official ballot and a receipt if no errors are detected;
collecting the official ballot; and
storing the official ballot.

31. The method according to claim 27, further comprising providing voting instructions to the voter.

32. The method according to claim 27, further comprising:
providing an opportunity to register a first time voter if the potential voter is determined to be eligible.

33. The method according to claim 30, further comprising:
updating a voting results database with the ballot received from the eligible voter;
providing access to the voting results database to the eligible voter; and
requiring the eligible voter to input the unique identifier in order to gain access to the voting results database.
